(19) United States
(12) Patent Application Publication
(10) Pub. No.: US 2011/0068570 A1
(43) Pub. Date: Mar. 24, 2011

(54) CLAMPING COMPONENT COMPRISING A CUTTING ELEMENT FOR ESTABLISHING AN ELECTRICALLY CONDUCTIVE CONNECTION

(76) Inventors: Hans-Peter Buttau, Lauffen (DE); Mario Hinderer, Fichtenberg Ot Langert (DE)

(21) Appl. No.: 12/772,375

(22) Filed: May 3, 2010

(30) Foreign Application Priority Data
Sep. 18, 2009 (DE) 10 2009 042 238.2

(51) Int. Cl. F16L 41/12

(52) U.S. Cl. 285/189

(57) ABSTRACT

A clamping component composed of metal and used to clamp a profiled element composed of metal has at least one clamping surface adapted to the profiled element, at least one cutting element which includes a cutting edge that extends beyond the clamping surface, thereby enabling the cutting element to penetrate the profiled element when the clamping component clamps the profiled element; and an engagement element for introducing a clamping force, wherein the cutting edge is situated at a slant and/or curve relative to the clamping surface such that the cutting edge initially touches the profiled element in a punctiform manner while the clamping part is clamped tightly, and an increasing region of the cutting edge subsequently penetrates the profiled element.

### CROSS-REFERENCE TO RELATED APPLICATION

The invention described and claimed hereinbelow is also described in German Patent Application DE 10 2009 042 238.2 filed on Sep. 18, 2009. This German Patent Application, whose subject matter is incorporated here by reference, provides the basis for a claim of priority of invention under 35 U.S.C. 119(a)-(d).

### BACKGROUND OF THE INVENTION

The present invention relates to a clamping component, and to a connecting system that includes a clamping component of this type.

DE 85 29 610 U1 makes known a clamping component in the form of a hammer nut. According to FIGS. 2 and 3 in DE 85 29 610 U1, clamping component 42 includes a body that is T-shaped overall and includes two clamping surfaces 50; 52 which lie in a plane. An engagement means 48 in the form of a thread is provided between the two clamping surfaces; engagement means 48 may be used to clamp the clamping component to profiled element 10 that is shown in FIG. 1 of DE 85 29 610 U1. The clamping component is clamped against a T-shaped groove 26 of the profiled element using a screw bolt 40.

The profiled element is an extruded aluminum profile. A “profiled element” therefore refers to an elongated element that has a substantially constant cross-sectional shape along its entire length. A profiled element of this type includes a non-electrically conductive layer of aluminum oxide on the surface, and so measures must be taken to establish an electrically conductive connection between the clamping component and the profiled element. An electrically conductive connection between the aforementioned components is necessary in order to prevent electrostatic charges and related discharges that may result, e.g., in damage being done to electronic components that are being handled within the vicinity of the clamping component.

Avoiding phenomena of this type is the subject matter, e.g., of DIN EN 61340-5-2. According to that publication, the objective is to establish an electrically conductive connection between the profiled element and the clamping component that has a resistance of a magnitude between 0.1 and 1000 MΩ, in order to prevent electrostatic charges and to keep the current intensities of electrostatic discharges so low that, e.g., electronic components do not become damaged.

To solve this problem, it is provided per DE 85 29 610 U1 that a plurality of cutting elements 54 is provided on the clamping surfaces, the straight cutting edges of the cutting elements being situated parallel to the flat clamping surfaces. The cutting elements penetrate the profiled element, breaking through its electrically insulating surface layer, thereby creating an electrically conductive connection between the profiled element and the clamping component. The resistance of the electrically conductive connection may be adjusted via the dimensions of the cutting elements such that it lies within the magnitude described above.

A further clamping component is made known in JP 2003-172 323 A. According to FIG. 2 in JP 2003-172 323 A, clamping component 2 is designed in the shape of a half shell overall, and a claw 5 is provided on one longitudinal end of the clamping component. According to FIG. 1 in JP 2003-172 323 A, two tube-type profiled elements 11; 12 are interconnected at a right angle to one another using two identical clamping components, the two clamping components being clamped to the two profiled elements using a single screw bolt. Clamping components of this type may be manufactured particularly cost-effectively out of zinc or a zinc alloy, or out of aluminum or an aluminum alloy, using a die casting method.

The problem results that the cutting elements made known in DE 85 29 610 U1 may not be related directly to a clamping component that is composed of zinc or a zinc alloy, or aluminum or an aluminum alloy, because the strength of zinc or aluminum is much less weaker than that of the steel of which the hammer nut is composed. In particular, it must be expected that the cutting elements will deform plastically during the clamping procedure, and they will not penetrate the profiled element. As a result, the electrically insulating surface layer of the profiled element is not breached, and so an electrically conductive connection between the clamping component and the profiled element is not established. An additional problem results, namely that the clamping surfaces no longer bear against the profiled element via their entire area since the cutting elements have become deformed. Excessive strain therefore results in the region of the deformed cutting elements, which results in creep strain of the aluminum material of the profiled element over time, thereby releasing the clamped connection.

### SUMMARY OF THE INVENTION

The object of the present invention is to overcome the aforementioned problems. According to the invention, this object is attained by the fact that the cutting edge is situated at a slant and/or curve relative to the clamping surface such that the cutting edge initially touches the profiled element in a punctiform manner while the clamping part is clamped tightly, and an increasing region of the cutting edge subsequently penetrates the profiled element.

Via this measure, it is ensured that the cutting element begins to penetrate the profiled element at a small, exactly defined point. As a result, at the beginning of the penetration procedure, particularly small and defined forces act on the cutting element. The cutting element may therefore be dimensioned such that plastic deformations are reliably ruled out. It is therefore ensured that the oxide layer of the profiled element, which is only a few μm thick, is breached.

As the cutting element penetrates further into the profiled element, the contact region between the cutting element and the profiled element increases, thereby causing the deformation forces to increase. Investigations performed by the applicant have shown that, via the proposed solution, it is always ensured that the cutting element penetrates the profiled element so far that the clamping surfaces of the clamping component bear against the profiled element via their entire area, and, simultaneously, a sufficient amount of resistance of the electrically conductive connection is present.

The cutting edge may be convexly curved relative to the clamping surface. The first punctiform contact therefore occurs at the highest point of the convexly curved cutting edge. Depending on the manner in which the clamping component is brought into contact with the profiled element, the position of this highest point may indeed vary slightly without the effect, according to the present invention, of the cutting edge being affected. This effect is particularly pronounced when the cutting edge is circularly or elliptically curved. However, a convexly curved cutting edge also refers to a cutting edge that is composed of a plurality of individual straight lines that, taken together, define a substantially convex curve. The corners of a curve of this type preferably form the highest point at which the first punctiform contact with the profiled element takes place.

A surface section that is recessed relative to the clamping surface may be provided on the clamping component, the cutting element being located in the region of the recessed surface section. The purpose is to make it possible to design the overhang of the cutting element over the clamping surface to be particularly small so that only slight deformations occur to the profiled element. The required clamping force is therefore so small that it may be applied by a single clamping means, e.g., a single screw bolt. A cutting element having a minimal height such as this is not easily manufactured using a die casting method, however, since all corners, in particular the corners at the base of the cutting element must be provided with a radius that must have a specified minimum size. The recess is therefore designed to be so deep that the corner radius is located completely inside the recess and is unable to come in contact with the profiled element. However, if the cutting element should become plastically deformed even if it is designed as described according to the present invention, then the recess has the advantage that the cutting element may deform into the recess, thereby ensuring that the profiled element bears against the clamping surface via its entire area in this case as well.

The recessed surface section is preferably located adjacent to or inside the clamping surface so that the cutting elements are located in the region of the clamping component in which the greatest clamping forces act.

The highest point of the cutting edge is preferably between 0.4 and 0.6 mm above the clamping surface. These dimensions results in an electrical contact resistance that corresponds to the values mentioned above.

The cutting edge may be provided with a cutting radius that is preferably between 0.1 and 0.2 mm. An ideally sharp cutting edge could deform in an undefined plastic manner when it penetrates the profiled rod. This is due to the fact that, in theory, infinitely large clamping surfaces occur at an ideally punctiform, initial contact point. Due to the proposed cutting radius, the clamping surfaces that occur are reduced to the point that plastic deformations on the cutting edge substantially do not occur. The size of the cutting radius is determined primarily by the preferred die casting of the clamping component. The smallest defined cutting element radius that can be manufactured is preferably used; the range of dimensions indicated above has proven particularly advantageous.

The cutting edge may be located substantially transversely to a longitudinal axis of the profiled element. The clamping force with which the clamping component is clamped onto the profiled element is usually oriented transversely to the longitudinal axis of the profiled element. The proposed orientation of the cutting edge therefore ensures that it is oriented parallel to the clamping direction. The cutting element therefore cuts into the profiled element similar to a knife, thereby resulting in a particularly good cutting effect of the cutting element. As a result, particularly small forces are required for the cutting element to penetrate the profiled element.

The clamping surface may be designed substantially circular-cylindrical in shape, the cutting edge being located substantially tangential to the clamping surface. The purpose of this is to ensure that, regardless of the exact manner in which the clamping component is brought into contact with the profiled element, the punctiform initial contact of the cutting edge with the profiled element occurs in the intended region of the cutting edge. If a cutting edge is used that is straight and slanted relative to the clamping surface, as described according to the present invention, then the wording “substantially tangential” should mean that there is a slight slant relative to the tangent.

The clamping component may be designed in the form of a half shell, and the recessed surface section is provided on at least one longitudinal-side edge of the half shell. As a result, the clamping surface does not extend across the entire circumferential region of the half shell, thereby ensuring that the clamping component and the profiled element bear against one another via their entire areas even if tolerance-related deviations of shape of the clamping surface relative to the profiled element occur. Recessed surface sections, which include a cutting element, are preferably located on both longitudinal-side edges of the clamping component.

The clamping component may be provided with an orienting projection in the region of the clamping surface, which may engage in a groove of the profiled element that extends in a longitudinal direction. Via the orienting projection, the clamping component should be oriented relative to the profiled element such that the cutting element is prevented from entering the longitudinally-extending groove of the profiled element. It is thereby ensured that the cutting element establishes the desired electrically conductive connection to the profiled element, even if it includes a groove that extends in the longitudinal direction.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a perspective view of a connecting device according to the present invention;

FIG. 1a shows a longitudinal cross section of the connecting system according to FIG. 1;

FIG. 2 shows an exploded view of two clamping components, according to the present invention, which are used in the connecting device according to FIG. 1;

FIG. 3 shows a longitudinal cross section of the clamping component according to FIG. 2;

FIG. 4 shows a side view of a cutting element according to the present invention;

FIG. 5 shows a cross section of the cutting element according to FIG. 4;

FIG. 6 shows a top view of the cutting element according to FIG. 4;

FIG. 7 shows a basic schematic view of the clamping procedure between the clamping component at a point in time at which the cutting element bears against the profiled element in a punctiform manner; and

FIG. 7a shows a view based on FIG. 7 at a point in time at which the profiled element bears against the profiled element via its entire surface.

### DESCRIPTION OF THE PREFERRED EMBODIMENTS

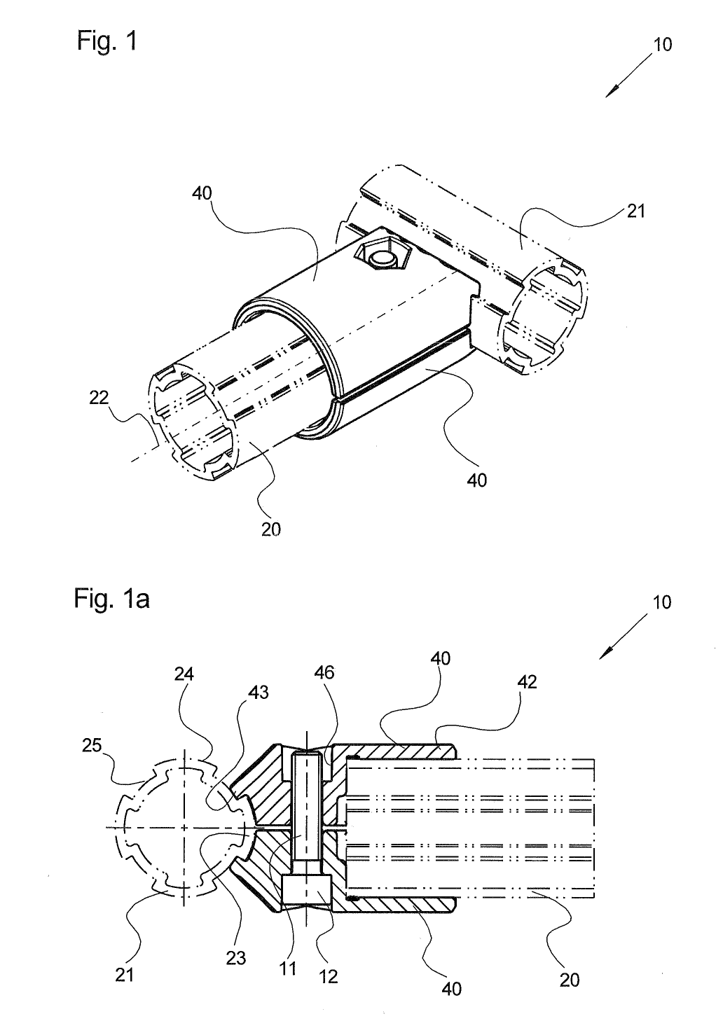

FIG. 1 and FIG. 1a show a connecting system 10 that is composed of a first profiled element 20 and a second profiled element 21 which are interconnected at a right angle via two identical clamping components 40 according to the present invention. Profiled elements 20; 21 are extruded out of aluminum, and so they have a constant cross-sectional shape, which is substantially tube-like, along their longitudinal axis 22. Four undercut projections 23 are provided on each of the profiled elements 20; 21; claws 43 of clamping components 40 engage in undercut projections 23 of second profiled element 21 in a form-fit manner, thereby fixedly connecting clamping components 40 to second profiled element 21.

First profiled element 20 is clamped to radial outer surfaces 24 of undercut projections 23 between clamping components 40 which are substantially half-shell shaped. Radial outer surfaces 24 of four undercut projections 23 define a circular cylinder to which half shells 42 of clamping components 40 are adapted. A screw bolt 11 extends through clamping components 40; screw bolt 11 is screwed into a (not depicted) hexagonal nut that is non-rotatably inserted into engagement means 46 in the form of a modified recess. Clamping components 40 may therefore be clamped to profiled elements 20; 21 by tightening screw bolt 11; head 12 of screw bolt 11 engages in engagement means 46 of the other clamping component 40.

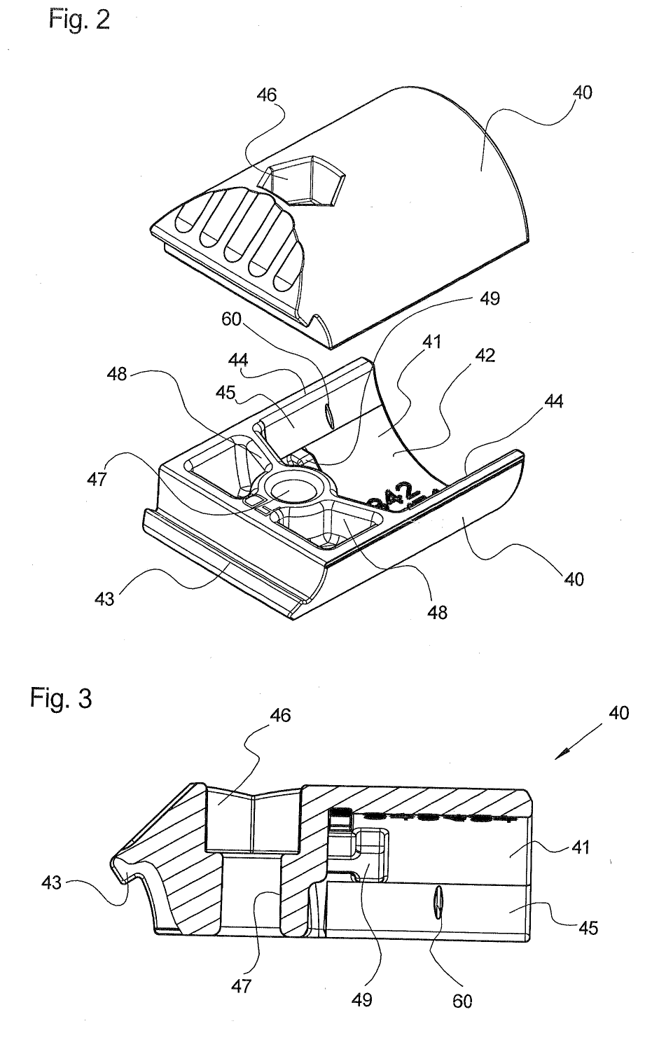

FIG. 2 shows clamping components 40, in an exploded view. Clamping components 40 are designed to be manufactured using the zinc die-casting method, and so particular value was placed on the fact that clamping components 40 have substantially the same wall thicknesses everywhere. For this reason, through-bore 47 was stabilized for the screw bolts using a plurality of ribs 48.

A recessed surface section 45, which is offset relative to circular-cylindrical clamping surface 41, is provided on each longitudinal-side edge 44 of half shell 42 of clamping component 40. A cutting element 60 according to the present invention is provided inside each recessed surface section 45, and is located transversely to the longitudinal axis (number 22, FIG. 1) of the first profiled element, and tangential to circular-cylindrical clamping surface 41.

FIG. 3 shows clamping component 40 in a longitudinal cross-section; orienting projection 49 is visible in the region of clamping surface 41. Orienting projection 49 is adapted to the grooves (number 25; FIG. 1a) between the undercut projections of the first profiled element, thereby ensuring that the first profiled element may be installed only in a rotational position between clamping components 40 in which it is ensured that the radial outer surface (number 24; FIG. 1a) of the undercut projections of the first profiled element come in contact with cutting elements 60 according to the present invention. Without the orienting projection, cutting element 60 could possibly enter the groove (number 25; FIG. 1a) between the undercut projections, and cutting element 60 would not touch the first profiled elements, and so there would be no electrical contact between the first profiled element and clamping component 40. In addition, orienting projection 49 prevents clamping components 40, once they have been clamped, from rotating about the longitudinal axis relative to the first profiled element. Orienting projection 49 is located in the vicinity of through-bore 47 for the screw bolt, thereby ensuring that the clamping component may also be used in combination with a fully circular-cylindrical tube. The latter is slid into clamping component 40 only until it reaches orienting projection 49.

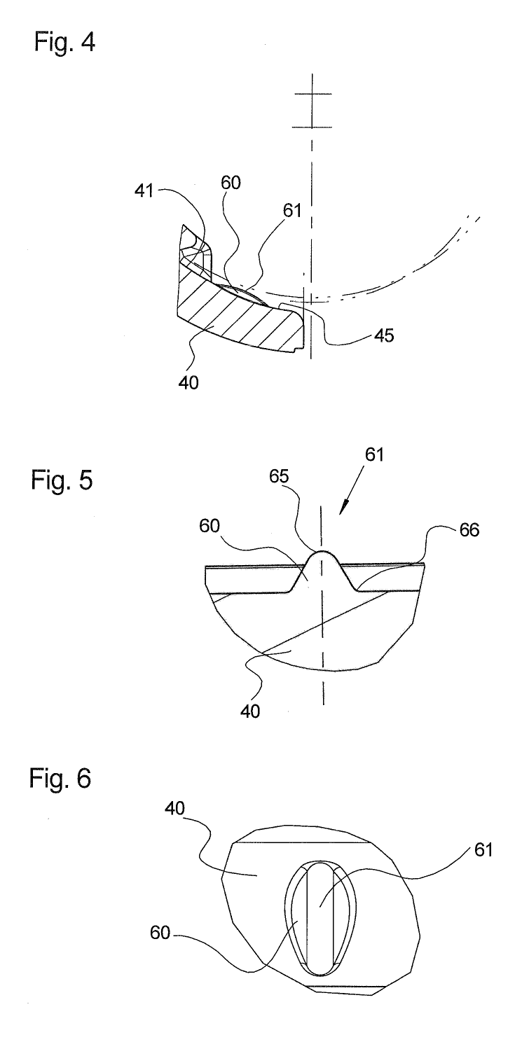

FIG. 4 shows a side view of cutting element 60, in which cutting edge 61 of cutting element 60, which is convexly curved relative to clamping surface 41, is visible. Cutting edge 61 is designed in the form of a circular arc.

FIG. 5 shows a cross section of cutting element 60, and particular reference is made to cutting radius 65 on cutting edge 61. In the present embodiment, cutting radius 65 does not exceed 0.2 mm. Reference is likewise made to curve radius 66 at the base of the cutting element, which is required to manufacture clamping component 40 using the die-casting method. The above-mentioned recessed surface section (number 45; FIG. 2) is designed to be so deep that curve radius 66 is located entirely inside the recess.

FIG. 6 shows a top view of cutting element 60, and it is clear that cutting edge 61 extends exactly in a straight line relative to this view, i.e., transversely to the longitudinal axis (number 22; FIG. 1).

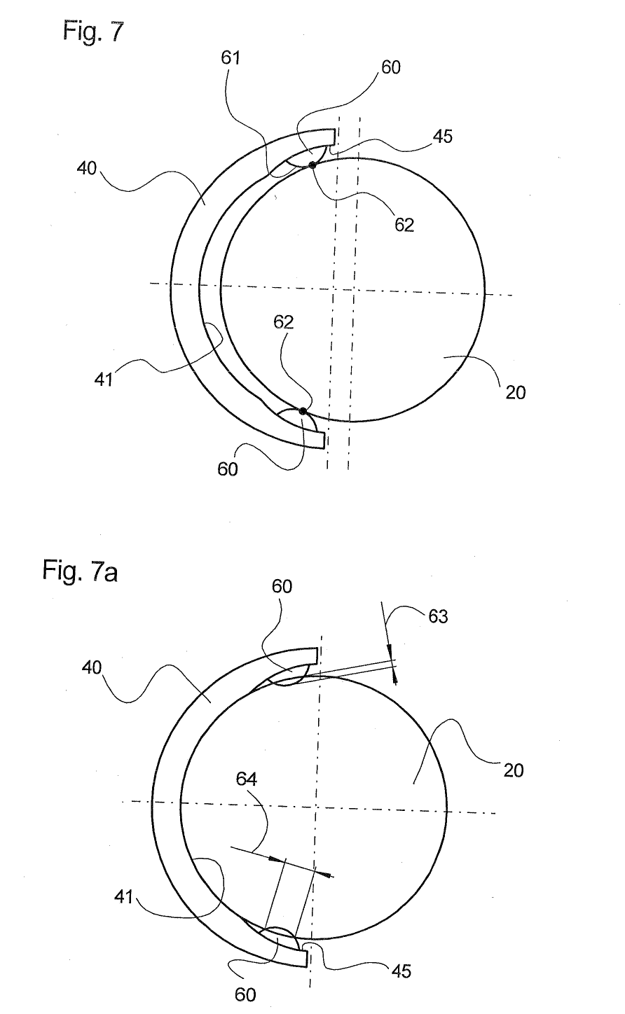

FIG. 7 and FIG. 7a are basic schematic views of two stages of the clamping procedure between a clamping component 40 and profiled element 20. The second clamping component was left out, to ensure simplicity. In FIG. 7, profiled element 20 bears against highest point 62 of cutting elements 60 in a punctiform manner, and it is located at a distance from clamping surface 41. In FIG. 7a, profiled element 20 bears against clamping surface 41 via its entire area, and cutting elements 60 have penetrated profiled element 20. In particular, a region 64 of the cutting edge, which is not merely punctiform, has penetrated profiled element 20.

Recessed surface section 45 of clamping component 40 is shown particularly clearly in FIG. 7a. Furthermore, overhang 63 of highest point 62 of the cutting edge above clamping surface 41 is indicated in FIG. 7a.

It will be understood that each of the elements described above, or two or more together, may also find a useful application in other types of constructions differing from the types described above.

While the invention has been illustrated and described as embodied in a clamping component comprising a cutting element or establishing an electrically conductive connection, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

What is claimed is:

1. A clamping component composed of metal and used to clamp a profiled element composed of metal, the clamping component comprising at least one clamping surface adapted to the profiled element; at least one cutting element which includes a cutting edge that extends beyond the clamping surface, thereby enabling the cutting element to penetrate the profiled element when the clamping component clamps the profiled element; and an engagement means for introducing a clamping force, wherein the cutting edge is situated at a slant and/or curve relative to the clamping surface such that the cutting edge initially touches the profiled element in a punctiform manner while the clamping part is clamped tightly, and an increasing region of the cutting edge subsequently penetrates the profiled element.

2. The clamping component as recited in claim 1, wherein the cutting edge is convexly curved relative to the clamping surface.

3. The clamping component as recited in claim 2, wherein the cutting edge is curved in a manner selected from the group consisting of circularly and elliptically.

4. The clamping component as recited in claim 1, wherein the clamping component includes a surface section that is recessed relative to the clamping surface, and the cutting element is located in a region of a recessed surface section.

5. The clamping component as recited in claim 4, wherein the recessed surface section is situated relative to the clamping surface in a manner selected from the group consisting of adjacent to the clamping surface and inside the clamping surface.

6. The clamping component as recited in claim 1, wherein a highest point of the cutting edge extends between 0.4 and 0.6 mm above the clamping surface.

7. The clamping component as recited in claim 1, wherein the cutting edge has a cutting radius.

8. The clamping component as recited in claim 7, wherein the cutting radius of the cutting edge is between 0.1 and 0.2 mm.

9. The clamping component as recited in claim 1, wherein the cutting edge is situated substantially transversely to a longitudinal axis of the profiled element.

10. The clamping component as recited in claim 1, wherein the clamping surface is substantially circular-cylindrical, and the cutting edge is situated substantially tangentially to the clamping surface.

11. The clamping component as recited in claim 10, related to claim 4, wherein the clamping component is a half shell-shaped, and a recessed surface section is provided on at least one longitudinal-side edge of a half shell.

12. The clamping component as recited in claim 11, wherein the clamping component includes, in a region of the clamping surface, an orienting projection that engages in a groove, which extends in a longitudinal direction, of the profiled element.

13. The clamping component as recited in claim 1, wherein the clamping component is composed of a material selected from the group consisting of zinc, zinc alloy, aluminum, or an aluminum alloy.

14. A connecting system comprising at least one profiled element, which is composed of metal, and at least one clamping component as recited in claim 1; the clamping surface of the clamping component is adapted to the profiled element, the clamping component is clamped to the profiled element via the clamping surface, and the cutting element has penetrated the profiled element.
